(19) United States
(12) Patent Application Publication
(10) Pub. No.: US 2026/0208997 A1
(43) Pub. Date: Jul. 23, 2026

(54) ELECTRODE ASSEMBLY MANUFACTURING APPARATUS AND METHOD FOR MANUFACTURING AN ELECTRODE ASSEMBLY

(71) Applicant: SK ON CO., LTD., Seoul (KR)

(72) Inventors: Ji Won YANG, Daejeon (KR); Sang Jun PARK, Daejeon (KR); Soo Yeon PARK, Daejeon (KR); Yun Jae KIM, Daejeon (KR)

(21) Appl. No.: 19/157,327

(22) PCT Filed: Feb. 15, 2024
(86) PCT No.: PCT/KR2024/095192

§ 371 Date: Aug. 15, 2025

(30) Foreign Application Priority Data
Feb. 15, 2023 (KR) 10-2023-0020298
Jun. 23, 2023 (KR) 10-2023-0081420
Dec. 28, 2023 (KR) 10-2023-0195812

(51) Int. Cl. B65H 39/04; B65H 1/14; B65H 5/06; B65H 43/04; H01M 10/04

(52) U.S. Cl. CPC B65H 39/04; B65H 1/14; B65H 5/062; B65H 43/04; H01M 10/0404; B65H 2511/24; B65H 2801/72

(57) ABSTRACT

The present disclosure relates to an electrode assembly manufacturing apparatus and a method for manufacturing an electrode assembly. Such an electrode assembly manufacturing apparatus and method for manufacturing an electrode assembly enable the electrode assembly to be manufactured using electrode plates that are not damaged in shape, are in a predetermined reference alignment state, and are free from foreign materials, and using separators that are not damaged in shape.

This application is a national stage application of PCT/KR2024/095192 filed on Feb. 15, 2024, which claims priority to Korean Patent Application No. 10-2023-0020298 filed on Feb. 15, 2023, Korean Patent Application No. 10-2023-0081420 filed on Jun. 23, 2023, and Korean Patent Application No. 10-2023-0195812 filed on Dec. 28, 2023. The disclosure of each of the foregoing applications is incorporated herein by reference in its entirety

### TECHNICAL FIELD

The present disclosure relates to an electrode assembly manufacturing apparatus and a method for manufacturing an electrode assembly, and more particularly, to an apparatus and a method for manufacturing an electrode assembly of a battery cell.

### BACKGROUND ART

A secondary battery cell is formed by stacking a positive electrode plate, a separator, and a negative electrode plate, and immersing them in an electrolyte solution. An electrode assembly included in such a battery cell is formed by alternately stacking the positive electrode plates and the negative electrode plates with the separator interposed therebetween.

Specifically, when an electrode plate composed of a positive electrode plate or a negative electrode plate is supplied to a stacking table, the positive electrode plates and the negative electrode plates are alternately stacked with a separator interposed therebetween on the stacking table to form an electrode assembly.

Meanwhile, a battery cell including an electrode assembly manufactured using electrode plates that are damaged in shape, not in a predetermined alignment state, or contain foreign materials may have degraded quality.

In addition, a battery cell including an electrode assembly manufactured using a separator that is folded and thus damaged in shape may also have degraded quality.

Therefore, it is necessary to develop an electrode assembly manufacturing apparatus and a method for manufacturing an electrode assembly that can manufacture an electrode assembly using electrode plates that are not damaged in shape, are in a predetermined alignment state, and are free from foreign materials, and using separators that are not damaged in shape.

### DISCLOSURE

### Technical Problem

An object of the present disclosure is to prevent defective battery cells by preventing electrode plates that are damaged in shape from being supplied and used in the manufacture of an electrode assembly.

Another object of the present disclosure is to prevent defective battery cells by preventing electrode plates that are not in a predetermined alignment state from being used in the manufacture of an electrode assembly.

Another object of the present disclosure is to detect electrode plates with foreign materials attached thereto, so as to prevent such electrode plates from being used in the manufacture of battery cells.

Another object of the present disclosure is to prevent defective battery cells by preventing separators that are damaged in shape from being used in the manufacture of an electrode assembly.

The electrode assembly manufacturing apparatus and method for manufacturing an electrode assembly according to the present disclosure can be widely used in green technology fields that utilize batteries, such as electric vehicles. In addition, battery cells manufactured by the electrode assembly manufacturing apparatus and method of the present disclosure can be used in eco-friendly electric vehicles and hybrid vehicles that help prevent climate change by reducing air pollution and greenhouse gas emissions.

### Technical Solution

As a technical means for solving the aforementioned technical problems, an electrode assembly manufacturing apparatus according to an embodiment of the present disclosure comprises: an electrode plate supply portion configured to supply an electrode plate formed of a positive electrode plate or a negative electrode plate; an electrode plate transfer portion configured to transfer the electrode plate; an electrode plate moving portion configured to transport the electrode plate from the electrode plate supply portion to the electrode plate transfer portion; an electrode plate stacking portion in which the positive electrode plate, the negative electrode plate, and a separator are stacked; an electrode plate conveying portion configured to convey the electrode plate transferred by the electrode plate transfer portion to the electrode plate stacking portion such that the positive electrode plate and the negative electrode plate are alternately supplied one by one to the electrode plate stacking portion; a separator supply portion configured to supply the separator to the electrode plate stacking portion; and a separator stacking portion configured to reciprocate the separator in a first movement direction parallel to a horizontal direction and a second movement direction opposite to the first movement direction to stack the separator between the positive electrode plate and the negative electrode plate that are alternately stacked, wherein the separator stacking portion may be configured to support a portion of the separator located between the separator supply portion and the electrode plate stacking portion to prevent folding of the separator.

In addition, the separator stacking portion may include: a first guide module installed above the electrode plate stacking portion and configured to guide movement of the separator; a second guide module installed below the first guide module and configured to reciprocate the separator in the first movement direction and the second movement direction; and a third guide module disposed between the first guide module and the second guide module and configured to support a portion of the separator to prevent folding of the separator.

In addition, the separator stacking portion may further include a movement module configured to move the second guide module and the third guide module in at least one direction among a direction parallel to the first movement direction, a direction parallel to the second movement direction, and a direction parallel to a vertical direction.

In addition, the third guide module may include: a fifth roller and a sixth roller disposed adjacent to each other and installed in the movement module; and a horizontal movement member configured to move the fifth roller and the sixth roller in the first movement direction or the second movement direction with respect to the movement module; wherein the fifth roller and the sixth roller may be moved by the movement module and the horizontal movement member while allowing the separator to pass between the fifth roller and the sixth roller.

In addition, the apparatus may further include a moving portion configured to move the electrode plate stacking portion in at least one direction among a direction parallel to the first movement direction, a direction parallel to the second movement direction, and a direction parallel to the vertical direction.

In addition, the moving portion may move the electrode plate stacking portion in the second movement direction when the movement module moves the second guide module and the third guide module in the first movement direction, and move the electrode plate stacking portion in the first movement direction when the movement module moves the second guide module and the third guide module in the second movement direction.

In addition, the apparatus may further include a controller configured to control a speed at which the separator supply portion supplies the separator, movement of the movement module, and movement of the moving portion.

In addition, the third guide module may include a tension measuring means configured to measure tension acting on the separator in the first movement direction or the second movement direction while the separator passes between the fifth roller and the sixth roller, and the controller may control a speed at which the separator supply portion supplies the separator, movement of the movement module, and movement of the moving portion such that the tension measured by the tension measuring means is maintained at a predetermined reference tension.

In addition, the electrode plate supply portion may include a magazine in which at least one electrode plate is loaded, and the magazine may include: a support plate configured to support the electrode plate and to be capable of moving up and down; and an electrode plate detection sensor configured to detect a position of the electrode plate, wherein the electrode plate detection sensor may detect whether the electrode plate is positioned at a predetermined gripping position to be gripped by the electrode plate moving portion, and the electrode plate moving portion may grip the electrode plate loaded in the magazine when the electrode plate is positioned at the gripping position.

In addition, the electrode plate supply portion may include: an inspection sensor configured to detect whether the electrode plate is formed in a predetermined shape; and an electrode plate discharge mechanism configured to discharge the electrode plate outside the electrode plate supply portion when the electrode plate is not formed in the predetermined shape.

In addition, the apparatus may further include an alignment inspection portion configured to inspect whether the electrode plate is in a predetermined reference alignment state when the electrode plate, which is transferred by the transfer portion, is positioned at a predetermined conveying position to be gripped by the electrode plate conveying portion, wherein the alignment inspection portion is configured to calculate correction information for correcting the alignment state of the electrode plate and to transmit the correction information to the electrode plate conveying portion, if the alignment state of the electrode plate is not in the reference alignment state.

In addition, the electrode plate conveying portion may grip the electrode plate and correct the alignment state of the electrode plate based on the correction information, and then convey the electrode plate to the electrode plate stacking portion.

In addition, when a state of the electrode plate conveying portion changes by moving the electrode plate based on the correction information, the electrode plate conveying portion may reset its state to a predetermined origin state before gripping another electrode plate after conveying one electrode plate to the electrode plate stacking portion.

In addition, the apparatus may further include a quality inspection portion including a first sensor configured to inspect whether a material other than a material constituting the electrode plate is attached to one surface of the electrode plate.

In addition, the quality inspection portion may include a second sensor configured to inspect whether a material other than a material constituting the electrode plate is attached to another surface of the electrode plate, the other surface being a surface of the electrode plate that comes into contact with the electrode plate transfer portion.

In addition, the second sensor may be a vision sensor configured to record a video of a predetermined area, disposed adjacent to the magazine, and configured to record a video of the other surface of the electrode plate conveyed to the electrode plate transfer portion by the electrode plate moving portion to inspect the electrode plate.

In addition, the apparatus may further include a third sensor configured to inspect whether the electrode plate conveyed to the electrode plate transfer portion by the electrode plate moving portion is in a state where a plurality of electrode plates are overlapped.

In addition, the third sensor may be a vision sensor configured to record a video of a predetermined area, disposed adjacent to the magazine, and configured to record a video of the electrode plate conveyed to the electrode plate transfer portion by the electrode plate moving portion in a direction parallel to a horizontal direction to inspect the electrode plate.

As a technical means for solving the aforementioned technical problems, a method for manufacturing an electrode assembly according to an embodiment of the present disclosure includes: supplying an electrode plate formed of a positive electrode plate or a negative electrode plate to an electrode plate supply portion; transporting the electrode plate from the electrode plate supply portion to an electrode plate transfer portion by an electrode plate moving portion; transferring the electrode plate by the electrode plate transfer portion; conveying the electrode plate transferred by the electrode plate transfer portion to an electrode plate stacking portion by an electrode plate conveying portion such that the positive electrode plate and the negative electrode plate are alternately supplied one by one to the electrode plate stacking portion; supplying a separator to the electrode plate stacking portion by a separator supply portion; and reciprocating the separator in a first movement direction parallel to a horizontal direction and a second movement direction opposite to the first movement direction by a separator stacking portion to stack the separator between the positive electrode plate and the negative electrode plate that are alternately stacked, wherein the separator stacking portion may be configured to support a portion of the separator located between the separator supply portion and the electrode plate stacking portion to prevent folding of the separator.

In addition, the separator stacking portion may include: a first guide module installed above the electrode plate stacking portion and configured to guide movement of the separator; a second guide module installed below the first guide module and configured to reciprocate the separator in the first movement direction and the second movement direction; and a third guide module disposed between the first guide module and the second guide module and configured to support a portion of the separator to prevent folding of the separator.

In addition, the separator stacking portion may further include a movement module configured to move the second guide module and the third guide module in at least one direction among a direction parallel to the first movement direction, a direction parallel to the second movement direction, and a direction parallel to a vertical direction.

In addition, the third guide module may include: a fifth roller and a sixth roller disposed adjacent to each other and installed in the movement module; and a horizontal movement member configured to move the fifth roller and the sixth roller in the first movement direction or the second movement direction with respect to the movement module; wherein the fifth roller and the sixth roller may be moved by the movement module and the horizontal movement member while allowing the separator to pass between the fifth roller and the sixth roller.

In addition, the electrode plate supply portion may include a magazine in which at least one electrode plate is loaded, and the magazine may include: a support plate configured to support the electrode plate and to be capable of moving up and down; and an electrode plate detection sensor configured to detect a position of the electrode plate, wherein the electrode plate detection sensor may detect whether the electrode plate is positioned at a predetermined gripping position to be gripped by the electrode plate moving portion, and the electrode plate moving portion may grip the electrode plate loaded in the magazine when the electrode plate is positioned at the gripping position.

In addition, the method may further include inspecting whether the electrode plate is in a predetermined reference alignment state when the electrode plate transferred by the electrode plate transfer portion is positioned at a predetermined conveying position to be gripped by the electrode plate conveying portion by an alignment inspection portion.

In addition, the method may further include inspecting whether a material other than a material constituting the electrode plate is attached to one surface of the electrode plate by a quality inspection portion between a step of transferring the electrode plate by the electrode plate transfer portion and a step of conveying the electrode plate to the electrode plate stacking portion by the electrode plate conveying portion.

Specific details of other embodiments for solving the problems are included in the description of the invention and the drawings.

### Advantageous Effects

As a technical means for solving the aforementioned technical problems, the electrode assembly manufacturing apparatus and the method for manufacturing an electrode assembly according to the present disclosure provide an effect of preventing defects in a battery cell including an electrode assembly manufactured using an electrode plate. This is achieved by detecting an electrode plate having a damaged shape through an inspection sensor and discharging it to the outside, or by preventing the shape of the electrode plate from being damaged by a mechanism that transports the electrode plate.

In addition, by inspecting the alignment state of the electrode plate through an alignment inspection portion and correcting the alignment state of the electrode plate through the electrode plate conveying portion, an effect of preventing defects in a battery cell including an electrode assembly manufactured using the electrode plate is provided.

In addition, since the quality inspection portion detects an electrode plate with a foreign substance attached or an electrode plate having a state in which multiple electrode plates are stacked together, the use of such electrode plates in the manufacturing of the electrode assembly can be prevented, thereby providing an effect of preventing defects in a battery cell including the electrode assembly.

In addition, since the third guide module of the separator stacking portion supports a portion of the separator and can apply a predetermined tension to the separator, the use of a separator having a damaged shape in the manufacturing of the electrode assembly can be prevented, thereby providing an effect of preventing defects in a battery cell including the electrode assembly.

### DESCRIPTION OF DRAWINGS

FIG. 1 illustrates an electrode assembly manufacturing apparatus according to an embodiment of the present disclosure.

FIG. 2 illustrates a magazine in which an electrode plate supported by a support plate is positioned below a gripping position.

FIG. 3 illustrates a magazine in which an electrode plate supported by a support plate is positioned at a gripping position.

FIG. 4 illustrates an electrode plate supply portion configured to form electrode plates from an electrode roll and load them into a magazine.

FIG. 5 illustrates an electrode plate supply portion configured to form electrode plates from an electrode roll and transfer them.

FIG. 6 illustrates an alignment inspection portion installed at a predetermined distance above the conveying position of the electrode plate transfer portion.

FIG. 7 illustrates an alignment inspection portion installed at a predetermined distance below the conveying position of the electrode plate transfer portion.

FIG. 8 illustrates an electrode plate in a reference alignment state being transferred through the electrode plate transfer portion.

FIG. 9 illustrates an electrode plate not in a reference alignment state being transferred through the electrode plate transfer portion.

FIG. 10 illustrates a position where a corner of an electrode plate should be located when in a reference alignment state, and the position of a corner of an electrode plate that is not in the reference alignment state.

FIG. 11 illustrates an electrode plate conveyed by an electrode plate conveying portion that transports the electrode plate in a first direction and a second direction without rotation.

FIG. 12 illustrates an electrode plate conveyed by an electrode plate conveying portion that transports the electrode plate in a first direction and a second direction while rotating.

FIG. 13 illustrates an alignment inspection portion installed on an electrode plate conveying portion.

FIG. 14 illustrates an example of an electrode plate conveying portion.

FIG. 15 illustrates an electrode plate conveying portion with an alignment inspection portion installed on an extension module.

FIG. 16 illustrates an electrode plate conveying portion with an alignment inspection portion installed on a gripping module.

FIG. 17 illustrates a position where a corner of an electrode plate should be located when in a stacking alignment state, and a position of a corner of an electrode plate that is not in the stacking alignment state.

FIG. 18 illustrates a first sensor formed as a photoelectric sensor inspecting one surface of an electrode plate.

FIG. 19 illustrates a first sensor formed as a vision sensor that records a video of a predetermined area to inspect one surface of an electrode plate.

FIG. 20 illustrates a first sensor formed as a vision sensor that scans a predetermined area to inspect one surface of an electrode plate.

FIG. 21 illustrates a first sensor formed as a magnetic proximity sensor inspecting one surface of an electrode plate.

FIG. 22 illustrates a second sensor inspecting another surface of an electrode plate.

FIG. 23 illustrates a third sensor inspecting a side surface of an electrode plate.

FIG. 24 illustrates an electrode plate stacking portion, a separator stacking portion, and a moving portion.

FIG. 25 illustrates a state in which a separator is stacked on an electrode plate by a separator stacking portion on an electrode plate stacking portion fixed in position.

FIG. 26 illustrates a state in which a separator is stacked on an electrode plate by a separator stacking portion on an electrode plate stacking portion moving in a horizontal direction.

FIG. 27 is a flowchart illustrating a method for manufacturing an electrode assembly according to an embodiment of the present disclosure.

### MODES OF THE INVENTION

Below, embodiments of the present disclosure will be described in detail with reference to the accompanying drawings so that those skilled in the art can easily implement them. However, the present disclosure may be implemented in various different forms and is not limited to the embodiments described herein. In addition, for clear explanation of the present disclosure, portions unrelated to the description have been omitted from the drawings, and similar components throughout the specification are designated by like reference numerals.

Throughout the present specification, when a certain part is described as being “connected” to another part, this includes not only cases where the parts are “directly connected” but also cases where they are “electrically connected” with other components interposed therebetween.

Throughout the present specification, when a member is described as being located “on” another member, this includes not only cases where the member is in contact with the other member, but also cases where another member exists between the two members.

Throughout the present specification, when a certain part is described as “including” a certain component, unless explicitly stated otherwise, it means that other components are not excluded and additional components may be included. Terms indicating degree, such as “about” and “substantially,” used throughout the present specification, are employed to mean values at or near the indicated numerical values when manufacturing and material tolerances inherent to the stated meaning are presented, and are used to prevent unscrupulous infringers from unfairly exploiting disclosures where exact or absolute numerical values are mentioned, for better understanding of the present disclosure. Terms such as “~step” or “~ing step” used throughout the present specification do not mean “a step for ~.”

Hereinafter, preferred embodiments of the present disclosure will be described in detail with reference to the accompanying drawings and the following description. However, the present disclosure is not limited to the embodiments described herein and may be embodied in other forms.

Throughout the specification, like reference numerals refer to like components.

Hereinafter, an electrode assembly manufacturing apparatus according to an embodiment of the present disclosure will be described.

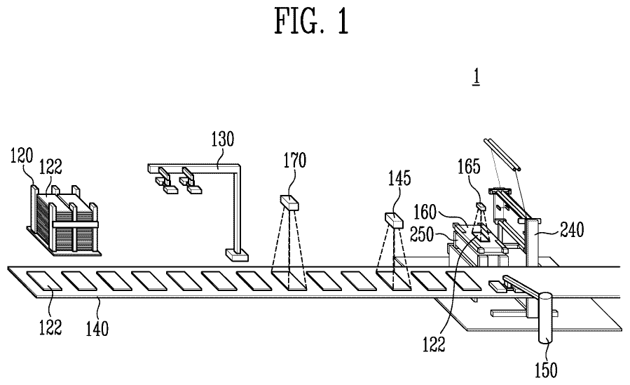

FIG. 1 illustrates an electrode assembly manufacturing apparatus according to an embodiment of the present disclosure.

Referring to FIG. 1, the electrode assembly manufacturing apparatus 1 may comprise an electrode plate supply portion 120, an electrode plate moving portion 130, an electrode plate transfer portion 140, an alignment inspection portion 145, an electrode plate conveying portion 150, an electrode plate stacking portion 160, an electrode plate alignment inspection portion 165, a quality inspection portion 170, a separator stacking portion 240, and a moving portion 250.

Although not shown in the drawings, the electrode assembly manufacturing apparatus may further include a separator supply portion and a control portion.

First, the electrode plate supply portion 120 will be described.

The electrode plate supply portion 120 may supply an electrode plate 122 formed as a positive electrode plate or a negative electrode plate.

For example, the electrode plate supply portion 120 may include at least one magazine 121 in which at least one electrode plate 122 is loaded.

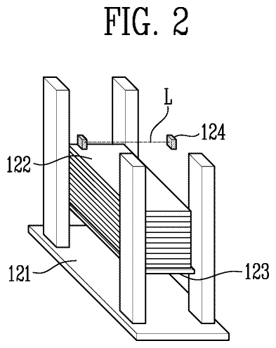

FIG. 2 illustrates a magazine in which an electrode plate supported by a support plate is positioned below a gripping position.

Referring to FIG. 2, the magazine 121 may include a support plate 123 and an electrode plate inspection sensor 124.

The support plate 123 can support at least one electrode plate 122 loaded in the magazine 121 and is configured to be capable of moving up and down.

The electrode plate inspection sensor 124 is configured to detect the position of the electrode plate 122 and may be configured as a conventional sensor capable of detecting the position of an object.

The electrode plate inspection sensor 124 may be capable of detecting whether the electrode plate 122 is positioned at a predetermined gripping position to be gripped by the electrode plate moving portion 130.

For example, as shown in FIG. 2, a plurality of electrode plate inspection sensors 124 may be provided on the magazine 121, and a virtual line L connecting one electrode plate inspection sensor 124 and another electrode plate inspection sensor 124 may be installed on the magazine such that it is parallel to the surface of the electrode plates 122 loaded in the magazine 121.

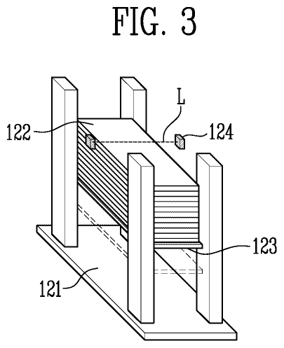

FIG. 3 illustrates a magazine in which an electrode plate supported by a support plate is positioned at a gripping position.

And, as shown in FIG. 3, when the support plate 123 rises and an electrode plate 122 loaded at the top of the magazine contacts the virtual line L, the electrode plate inspection sensor 124 can detect that the electrode plate 122 loaded at the top of the magazine 121 is positioned at the predetermined gripping position.

Meanwhile, an upper portion of a predetermined object may be a position located farther in a direction opposite to the direction in which gravity acts than the predetermined object, and a lower portion of the predetermined object may be a position located farther in the direction in which gravity acts than the predetermined object.

Thus, when the electrode plate inspection sensor 124 detects that the electrode plate 122 loaded at the top of the magazine 121 is positioned at the predetermined gripping position, the electrode plate moving portion 130 can grip the electrode plate 122 loaded at the top of the magazine 121.

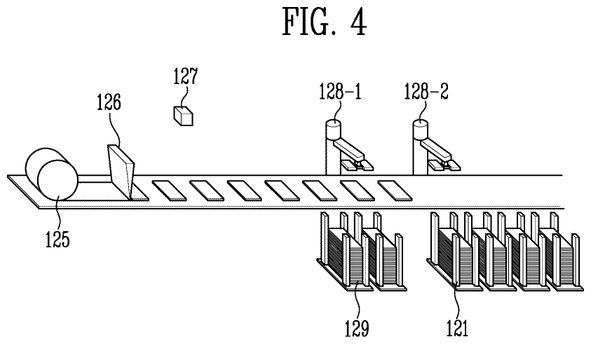

FIG. 4 illustrates an electrode plate supply portion configured to form electrode plates from an electrode roll and load them into a magazine.

For another example, as shown in FIG. 4, the electrode plate supply portion 120 may include an electrode roll 125, a cutting mechanism 126, a detection sensor 127, an electrode plate discharge mechanism 128-1, an electrode plate receiving mechanism 129, an electrode plate loading mechanism 128-2, and a magazine 121.

As shown in FIG. 4, the electrode roll 125 is an electrode wound in a roll shape.

The cutting mechanism 126 may cut a portion of the electrode roll 125 to form at least one electrode plate 122 when one side of the electrode roll 125 is unwound and moved by a conveyor belt or the like.

The detection sensor 127 can detect whether the electrode plate 122 formed by the cutting mechanism 126 is damaged in shape. For example, the detection sensor 127 may be configured as a visual sensor to detect whether the electrode plate 122 is formed in a predetermined shape without damage.

The electrode plate discharge mechanism 128-1 is configured as a mechanism capable of gripping and conveying the electrode plate 122, and may discharge the electrode plate 122 outside the electrode plate supply portion 120 when the electrode plate 122 is not formed in a predetermined shape. That is, the electrode plate discharge mechanism 128-1 can discharge an electrode plate 122 having a damaged shape to the outside.

The electrode plate receiving mechanism 129 can receive an electrode plate 122 having a damaged shape discharged by the electrode plate discharge mechanism 128-1, and the electrode plate 122 received by the electrode plate receiving mechanism 129 may be discarded.

The electrode plate loading mechanism 128-2 is configured as a mechanism capable of gripping and conveying the electrode plate 122, and can load the electrode plate 122 that has not been discharged outside by the electrode plate discharge mechanism 128-1 into the magazine 121.

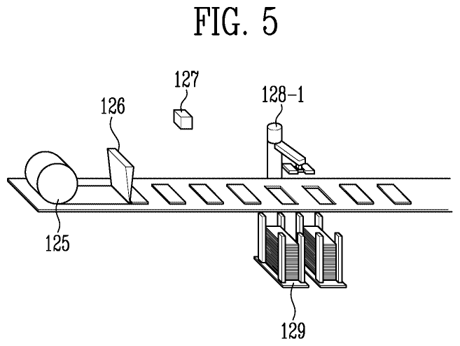

FIG. 5 illustrates an electrode plate supply portion configured to form electrode plates from an electrode roll and transfer them.

For another example, as shown in FIG. 5, the electrode plate supply portion 120 may include an electrode roll 125, a cutting mechanism 126, a detection sensor 127, an electrode plate discharge mechanism 128-1, and an electrode plate receiving mechanism 129.

The configurations of the electrode roll 125, cutting mechanism 126, detection sensor 127, electrode plate discharge mechanism 128-1, and electrode plate receiving mechanism 129 shown in FIG. 5 are the same as those of the electrode roll 125, cutting mechanism 126, detection sensor 127, electrode plate discharge mechanism 128-1, and electrode plate receiving mechanism 129 shown in FIG. 4 described above.

However, the electrode plate supply portion 120 shown in FIG. 5 differs from the electrode plate supply portion 120 shown in FIG. 4 in that the electrode plate 122, which is not discharged outside by the electrode plate discharge mechanism 128-1, is not loaded into the magazine 121 but is configured to be transferred toward the electrode plate stacking portion 160 described later. In this case, the electrode plate 122 may be transferred toward the electrode plate stacking portion 160 by a conventional transfer means including a conveyor belt.

Next, the electrode plate moving portion 130 will be described.

The electrode plate moving portion 130 may perform a function of conveying the electrode plate 122 supplied by the electrode plate supply portion 120 to an electrode plate transfer portion 140 to be described later, and may be configured as a mechanism capable of gripping and conveying the electrode plate 122.

For example, the electrode plate moving portion 130 may be configured by a conventional machine including a P&P (Pick and Place) machine or an SCARA robot, but the configuration of the electrode plate moving portion 130 is not limited thereto.

The electrode plate moving portion 130 can grip the electrode plate 122 and rotate it while maintaining one surface of the electrode plate 122 parallel to and perpendicular to the direction in which gravity acts.

The electrode plate moving portion 130 may move the electrode plate 122 in a first direction and a second direction perpendicular to the first direction to convey it to the electrode plate transfer portion 140. Here, the first direction may be a direction parallel to the direction in which gravity acts, and the second direction may be a direction perpendicular to the direction in which gravity acts.

Further, when the electrode plate supply portion 120 includes a plurality of magazines 121, the electrode plate moving portion 130 may grip electrode plates 122 from each of the plurality of magazines 121 sequentially or simultaneously and convey them to the electrode plate transfer portion 140.

In this case, the electrode plate moving portion 130 may grip one electrode plate 122 from each of the plurality of magazines 121.

Meanwhile, the predetermined gripping position of the electrode plate 122 may be a position set such that the electrode plate 122 is not damaged by the force acting between the electrode plate moving portion 130 and the electrode plate 122 when the electrode plate moving portion 130 contacts and grips the electrode plate 122.

That is, if the electrode plate 122 is not positioned at the predetermined gripping position and the electrode plate moving portion 130 grips the electrode plate 122, the shape of the electrode plate 122 may be damaged due to the force acting between the electrode plate moving portion 130 and the electrode plate 122.

However, as described above, the electrode plate moving portion 130 of the present disclosure is configured to grip the electrode plate 122 only when the electrode plate 122 is positioned at the predetermined gripping position, thereby preventing the shape of the electrode plate 122 from being damaged by the force acting between the electrode plate 122 and the electrode plate moving portion 130.

Therefore, it is possible to prevent the battery cell from including an electrode plate 122 having a damaged shape.

Next, the electrode plate transfer portion 140 will be described.

As shown in FIG. 1, the electrode plate transfer portion 140 may perform a function of transferring the electrode plate 122 conveyed by the electrode plate moving portion 130.

The electrode plate transfer portion 140 may be configured as a conventional conveying mechanism including a conveyor belt or a moving plate capable of reciprocating an object, but the configuration of the electrode plate transfer portion 140 is not limited thereto.

In this case, the electrode plate 122 may be placed on the electrode plate transfer portion 140 such that the two longest sides among the four sides of the electrode plate 122 are parallel or perpendicular to the direction in which the electrode plate transfer portion 140 transfers the electrode plate 122, and transferred in that state.

Meanwhile, since the electrode plate moving portion 130 can grip and rotate the electrode plate 122, the magazine 121 may be arranged adjacent to the electrode plate transfer portion 140 so that the two longest sides among the four sides of the electrode plate 122 loaded in the magazine 121 are parallel or perpendicular to the direction in which the electrode plate transfer portion 140 transfers the electrode plate 122.

Next, the alignment inspection portion 145 will be described.

The alignment inspection portion 145 may include an imaging portion configured to record a video of the electrode plate 122, and may be formed as a conventional vision sensor capable of recording a video of a predetermined object and identifying a shape and a form of the predetermined object, but is not limited thereto.

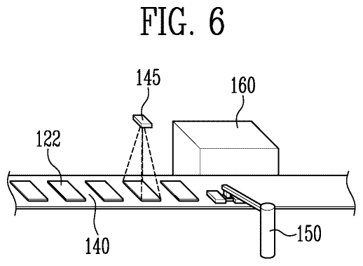

FIG. 6 illustrates an alignment inspection portion installed at a predetermined distance above the conveying position of the electrode plate transfer portion.

Such the alignment inspection portion 145 may be installed at a predetermined first installation position spaced a predetermined distance from the conveying position, as shown in FIG. 6, and can inspect the alignment state of the electrode plate 122.

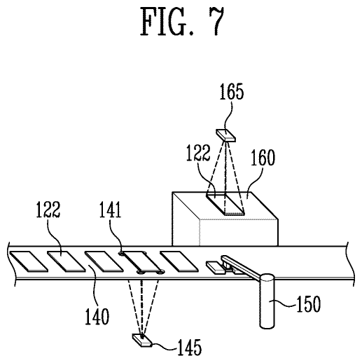

FIG. 7 illustrates an alignment inspection portion installed at a predetermined distance below the conveying position of the electrode plate transfer portion.

Meanwhile, the alignment inspection portion 145 may be installed at a predetermined second installation position spaced a predetermined distance from the conveying position and located below the electrode plate transfer portion 140, as shown in FIG. 7, and may inspect the alignment state of the electrode plate 122.

At this time, the electrode plate transfer portion 140 may have a plurality of holes 141 formed at positions where corners of the electrode plate 122 are located when the electrode plate 122 is positioned at a predetermined conveying position to be gripped by the electrode plate conveying portion 150, so that the alignment inspection portion 145 located below the electrode plate transfer portion 140 can detect the positions of the corners of the electrode plate 122.

Thus, by forming a plurality of holes 141 in the electrode plate transfer portion 140, the alignment inspection portion 145 can detect the positions of the corners of the electrode plate 122 exposed through the plurality of holes 141 and inspect the alignment state of the electrode plate 122.

Specifically, the alignment inspection portion 145 may inspect whether the electrode plate 122 transferred by the electrode plate transfer portion 140 is in a predetermined reference alignment state when positioned at a predetermined conveying position to be gripped by the electrode plate conveying portion 150.

Further, when the alignment state of the electrode plate 122 is not the reference alignment state, the alignment inspection portion 145 may calculate correction information for correcting the alignment state of the electrode plate 122 to the reference alignment state and transmit the correction information to the electrode plate conveying portion 150.

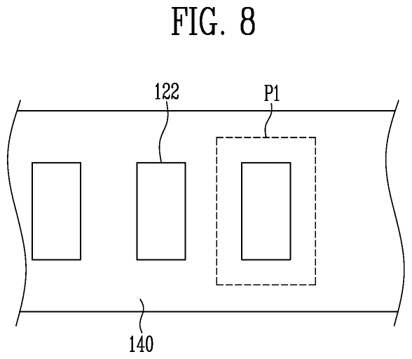

FIG. 8 illustrates an electrode plate in a reference alignment state being transferred through the electrode plate transfer portion.

For example, as shown in FIG. 8, when the alignment state of the electrode plate 122 positioned at the conveying position P1 is the reference alignment state, the alignment inspection portion 145 may not calculate correction information to be transmitted to the electrode plate conveying portion 150.

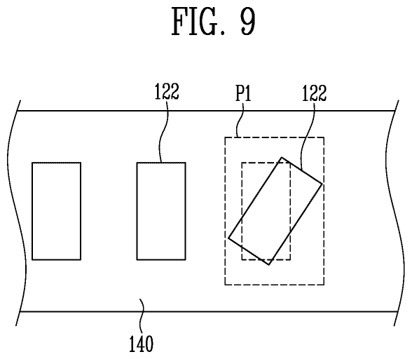

FIG. 9 illustrates an electrode plate not in a reference alignment state being transferred through the electrode plate transfer portion.

However, as shown in FIG. 9, when the alignment state of the electrode plate 122 positioned at the conveying position P1 is not the reference alignment state, the alignment inspection portion 145 may calculate correction information to be transmitted to the electrode plate conveying portion 150.

The correction information may include information for moving the electrode plate 122 so that each of the plurality of corners of the electrode plate 122 is positioned at a location where it should be when the electrode plate 122 is in the reference alignment state.

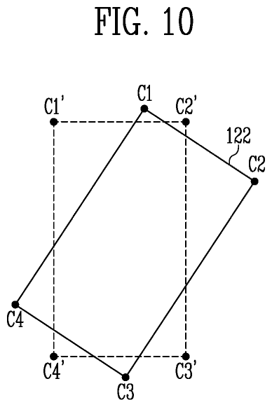

FIG. 10 illustrates a position where a corner of an electrode plate should be located when in a reference alignment state, and the position of a corner of an electrode plate that is not in the reference alignment state.

For example, referring to FIG. 10, the correction information may include information for moving the electrode plate 122 such that the first corner of the electrode plate 122 moves from the first position C1 to the first prime position C1′, the second corner moves from the second position C2 to the second prime position C2′, the third corner moves from the third position C3 to the third prime position C3′, and the fourth corner moves from the fourth position C4 to the fourth prime position C4′, thereby correcting the alignment state of the electrode plate 122 to the reference alignment state.

Further, the correction information may include information for moving the electrode plate 122 so that at least two or more of the plurality of corners of the electrode plate 122 are positioned at locations where they should be when the electrode plate 122 is in the reference alignment state.

When at least two or more corners among the plurality of corners of the electrode plate 122 are positioned at the locations where they should be when the electrode plate 122 is in the reference alignment state, the remaining corners will also be positioned at the locations where they should be in the reference alignment state.

Meanwhile, the correction information may include information for moving the electrode plate 122 so that at least two or more vertices among the plurality of vertices of the electrode plate 122 are positioned at locations where they should be when the electrode plate 122 is in the reference alignment state.

At this time, the correction information may include information for moving the electrode plate 122 so that each of the plurality of vertices of the electrode plate 122 is positioned at a location where it should be when the electrode plate 122 is in the reference alignment state.

Such correction information may include one or more of the following: information for moving the electrode plate 122 in a first alignment direction parallel to the horizontal direction; information for moving the electrode plate 122 in a second alignment direction parallel to the horizontal direction and perpendicular to the first alignment direction; and information for rotating the electrode plate 122 so that one surface of the electrode plate 122 remains parallel to the horizontal direction while rotating.

At this time, the horizontal direction may be a direction perpendicular to the direction in which gravity acts.

Therefore, based on the correction information calculated by the alignment inspection portion 145, the electrode plate conveying portion 150, which will be described later, can move the electrode plate 122 in the horizontal direction or move and rotate the electrode plate 122 in the horizontal direction to correct the alignment state of the electrode plate 122 to the reference alignment state.

Next, the electrode plate conveying portion 150 will be described.

The electrode plate conveying portion 150 may perform a function of conveying the electrode plate 122 transferred by the electrode plate transfer portion 140 to an electrode plate stacking portion 160 to be described later.

For example, the electrode plate conveying portion 150 may alternately supply the positive electrode plate and the negative electrode plate one by one to the electrode plate stacking portion 160.

Such an electrode plate conveying portion 150 may be configured by a conventional machine including a P&P (Pick and Place) machine or a SCARA robot, but the configuration of the electrode plate conveying portion 150 is not limited thereto.

The electrode plate conveying portion 150 can grip the electrode plate 122 and rotate it while maintaining one surface of the electrode plate 122 parallel to and perpendicular to the direction in which gravity acts.

Further, the electrode plate conveying portion 150 may move the electrode plate 122 in a first direction and a second direction perpendicular to the first direction to convey it to the electrode plate stacking portion 160. Here, the first direction may be a direction parallel to the direction in which gravity acts, and the second direction may be a direction perpendicular to the direction in which gravity acts.

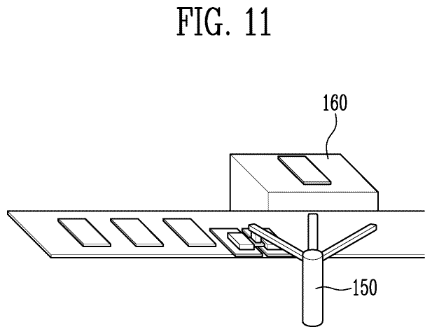

FIG. 11 illustrates an electrode plate conveyed by an electrode plate conveying portion that transports the electrode plate in a first direction and a second direction without rotation.

And, as shown in FIG. 11, the electrode plate conveying portion 150 may move the electrode plate 122 in a first direction and a second direction perpendicular to the first direction to convey it to the electrode plate stacking portion 160.

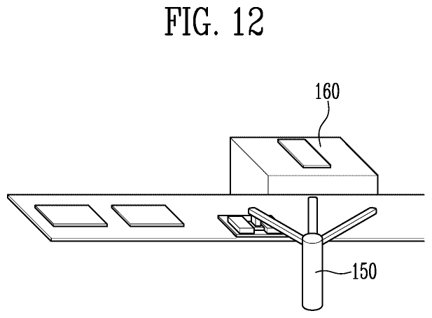

FIG. 12 illustrates an electrode plate conveyed by an electrode plate conveying portion that transports the electrode plate in a first direction and a second direction while rotating.

Further, as shown in FIG. 12, the electrode plate conveying portion 150 may move the electrode plate 122 in a first direction and a second direction perpendicular to the first direction while rotating the electrode plate 122 and convey it to the electrode plate stacking portion 160. That is, the electrode plate conveying portion 150 may rotate the electrode plate 122 so that the directions in which the two longer sides among the four sides of the electrode plate 122 face are changed, and convey it to the electrode plate stacking portion 160.

Meanwhile, the first direction may be a direction parallel to the direction in which gravity acts, and the second direction may be a direction perpendicular to the direction in which gravity acts.

In other words, the electrode plate conveying portion 150 may move the electrode plate 122 in a vertical direction and a horizontal direction to convey it to the electrode plate stacking portion 160, and may move and rotate the electrode plate 122 in the vertical and horizontal directions to convey it to the electrode plate stacking portion 160. At this time, the vertical direction may be a direction parallel to the direction in which gravity acts.

The electrode plate conveying portion 150 may move the gripped electrode plate 122 based on correction information received from the alignment inspection portion 145 so that the alignment state of the electrode plate 122 becomes the reference alignment state, and then convey the electrode plate 122 to the electrode plate stacking portion 160.

That is, based on the correction information, the electrode plate conveying portion 150 may move the gripped electrode plate 122 in one or more of a first alignment direction and a second alignment direction so that at least two or more corners among the plurality of corners of the electrode plate 122 are positioned at locations where they should be when the electrode plate 122 is in the reference alignment state, and may also rotate the electrode plate 122.

Meanwhile, when the electrode plate conveying portion 150 moves the electrode plate 122 based on the correction information and the state of the electrode plate conveying portion 150 changes, the electrode plate conveying portion 150 can preliminarily change its state to a predetermined origin state before gripping the electrode plate 122.

At this time, the electrode plate conveying portion 150 can preliminarily change its state based on the correction information before gripping another electrode plate 122 after conveying one electrode plate 122 to the electrode plate stacking portion 160.

That is, the electrode plate conveying portion 150 conveys the electrode plate 122 to the electrode plate stacking portion 160, preliminarily changes its state based on the correction information, grips the electrode plate 122 in the changed state, moves the electrode plate 122 to the reference alignment state so that the state of the electrode plate 122 becomes the predetermined origin state, and then repeats the process of conveying the electrode plate 122 to the electrode plate stacking portion 160.

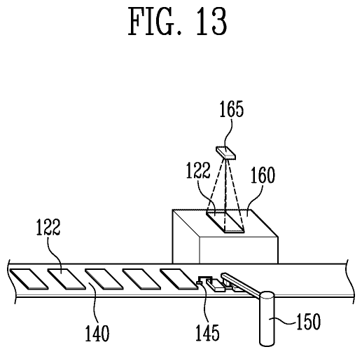

FIG. 13 illustrates an alignment inspection portion installed on an electrode plate conveying portion.

Meanwhile, as shown in FIG. 13, the alignment inspection portion 145 may be installed on the electrode plate conveying portion 150.

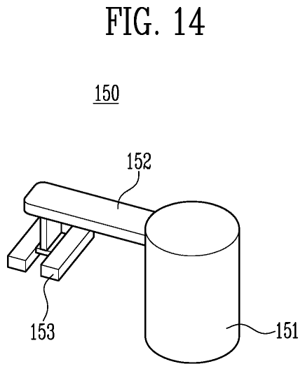

FIG. 14 illustrates an example of an electrode plate conveying portion.

Referring to FIG. 14, an example of the electrode plate conveying portion 150 where the alignment inspection portion 145 is installed includes a main body 151, an extension module 152, and a gripping module 153.

The main body 151 may be formed to support the electrode plate conveying portion 150.

The extension module 152 is connected to the main body 151 and may be formed to extend in a direction parallel to the horizontal direction from the main body 151.

The gripping module 153 is coupled to the extension module 152 so as to be disposed below the extension module 152 and can contact and grip the electrode plate 122. For example, the gripping module 153 may be configured such that one surface contacting the electrode plate 122 sucks air and grips the electrode plate 122 contacting that surface by using suction force.

Meanwhile, to grip the electrode plate 122 positioned on the electrode plate transfer portion 140 with the gripping module 153 or to correct the alignment state of the electrode plate 122 gripped by the gripping module 153, at least one of the extension module 152 and the gripping module 153 may be configured to be movable relative to the main body 151 in at least one direction among the horizontal and vertical directions, and the gripping module 153 may be configured to rotate the gripped electrode plate 122.

An alignment inspection portion 145 may be installed at a predetermined position of the electrode plate conveying portion 150 formed as described above to inspect the alignment state of the electrode plate 122 positioned at the conveying position P1 of the electrode plate transfer portion 140.

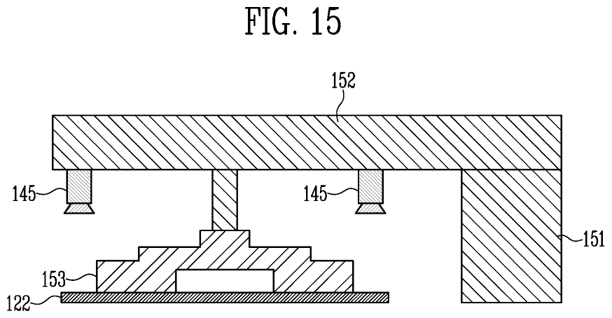

FIG. 15 illustrates an electrode plate conveying portion with an alignment inspection portion installed on an extension module.

For example, as shown in FIG. 15, at least one alignment inspection portion 145 is installed on the extension module 152 of the electrode plate conveying portion 150, and is configured to inspect an alignment state of the electrode plate 122 positioned at a conveying position P1 of the electrode plate transfer portion 140.

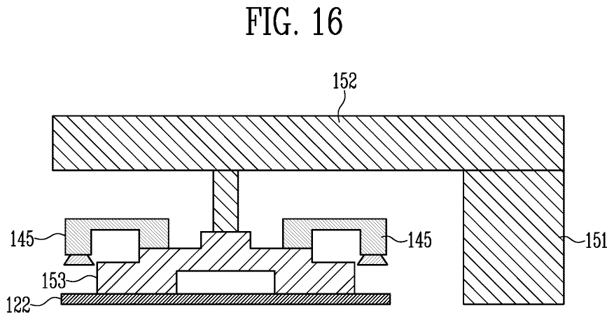

FIG. 16 illustrates an electrode plate conveying portion with an alignment inspection portion installed on a gripping module.

For example, as shown in FIG. 16, at least one alignment inspection portion 145 may be installed on the gripping module 153 of the electrode plate conveying portion 150 to inspect the alignment state of the electrode plate 122 positioned at the conveying position P1 of the electrode plate transfer portion 140.

Next, the electrode plate stacking portion 160 will be described.

The electrode plate stacking portion 160 is formed so that the electrode plates 122 conveyed by the electrode plate conveying portion 150 can be stacked.

Specifically, the electrode plate stacking portion 160 may be formed so that the positive electrode plates and the negative electrode plates conveyed by the electrode plate conveying portion 150 are alternately stacked with a separator therebetween.

The electrode plate stacking portion 160 may be configured as a table on which a predetermined object can be placed, but the configuration of the electrode plate stacking portion 160 is not limited thereto.

Next, the stacking portion alignment inspection portion 165 will be described.

The stacking portion alignment inspection portion 165 may include photographing means for photographing the electrode plate 122 and may be configured by a conventional vision sensor capable of identifying the shape and form of a predetermined object by photographing the object. However, the configuration of the stacking portion alignment inspection portion 165 is not limited thereto.

As shown in FIG. 1, the stacking portion alignment inspection portion 165 is installed at a predetermined third installation position spaced a predetermined distance from the stacking portion 160 and can inspect the alignment state of the electrode plate 122 stacked on the electrode plate stacking portion 160.

Specifically, the stacking portion alignment inspection portion 165 can inspect whether the electrode plate 122 stacked on the electrode plate stacking portion 160 is in a predetermined stacking alignment state.

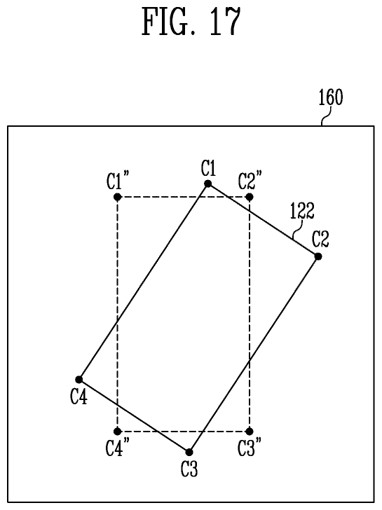

FIG. 17 illustrates a position where a corner of an electrode plate should be located when in a stacking alignment state, and a position of a corner of an electrode plate that is not in the stacking alignment state.

For example, referring to FIG. 17, when the electrode plate 122 is in the stacking alignment state, the corners of the electrode plate 122 should be positioned at the first double-prime position C1″, the second double-prime position C2″, the third double-prime position C3″, and the fourth double-prime position C4″, respectively.

At this time, if the first corner of the electrode plate 122 that should be positioned at the first double-prime position C1″ is located at the first position C1, or the second corner that should be at the second double-prime position C2″ is located at the second position C2, or the third corner that should be at the third double-prime position C3″ is located at the third position C3, or the fourth corner that should be at the fourth double-prime position C4″ is located at the fourth position C4, the stacking portion alignment inspection portion 165 may determine that the alignment state of the electrode plate 122 is not the stacking alignment state.

Thus, when the stacking portion alignment inspection portion 165 determines that the alignment state of the electrode plates 122 stacked on the electrode plate stacking portion 160 is not the stacking alignment state, the electrode plates 122 stacked on the electrode plate stacking portion 160 may be discharged to the outside of the electrode plate stacking portion 160.

Meanwhile, the stacking portion alignment inspection portion 165 may inspect the alignment state of the electrode plate 122 immediately after the electrode plate conveying portion 150 conveys the electrode plate 122 to the electrode plate stacking portion 160.

At this time, to prevent a portion of the electrode plate conveying portion 150 from being positioned between the electrode plate 122 and the stacking portion alignment inspection portion 165 so that the electrode plate 122 cannot be inspected by the stacking portion alignment inspection portion 165, the electrode plate conveying portion 150 may be formed to have a shape that does not obstruct the inspection of the electrode plate 122 by the stacking portion alignment inspection portion 165.

Next, the quality inspection portion 170 will be described.

The quality inspection portion 170 can inspect whether a material other than the material constituting the electrode plate 122 is attached to the electrode plate 122, and may also inspect whether a plurality of electrode plates 122 are in an overlapped state.

The quality inspection portion 170 may include a first sensor 172, a second sensor 174, and a third sensor 176.

The first sensor 172 is installed above the electrode plate transfer portion 140 at a predetermined distance spaced apart therefrom and can inspect one surface of the electrode plate 122 transferred by the electrode plate transfer portion 140. At this time, one surface of the electrode plate 122 may be the surface facing the first sensor 172.

Specifically, the first sensor 172 can inspect whether a material other than the material constituting the electrode plate 122 is attached to one surface of the electrode plate 122. In other words, the first sensor 172 can inspect whether a foreign substance is attached to one surface of the electrode plate 122.

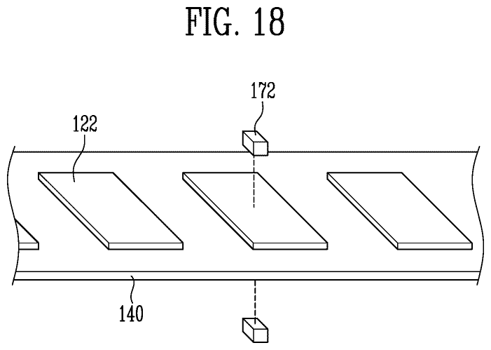

FIG. 18 illustrates a first sensor formed as a photoelectric sensor inspecting one surface of an electrode plate.

For example, as shown in FIG. 18, the first sensor 172 may be formed as a conventional photoelectric sensor and can inspect whether a material other than the material constituting the electrode plate 122 is attached to one surface of the electrode plate 122.

At this time, the electrode plate transfer portion 140 transfers the electrode plate 122 by repeating a moving step of moving the electrode plate 122 for a predetermined first time and a stopping step of stopping the movement of the electrode plate 122 for a predetermined second time, and the first sensor 172 can inspect the electrode plate 122 by irradiating light onto the electrode plate 122 when the electrode plate transfer portion 140 performs the stopping step.

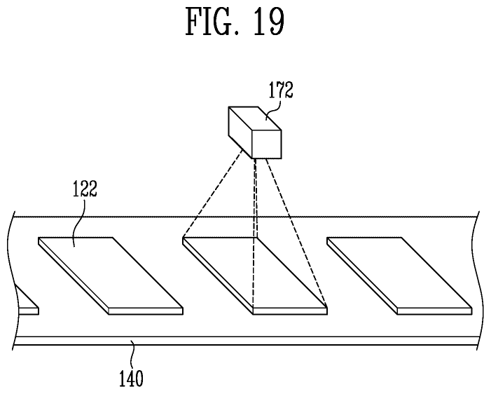

FIG. 19 illustrates a first sensor formed as a vision sensor that records a video of a predetermined area to inspect one surface of an electrode plate.

As another example, as shown in FIG. 19, the first sensor 172 may be formed as a conventional vision sensor capable of photographing a predetermined area and can inspect whether a material other than the material constituting the electrode plate 122 is attached to one surface of the electrode plate 122.

At this time, the electrode plate transfer portion 140 transfers the electrode plate 122 while repeating the aforementioned moving step and stopping step, and the first sensor 172 can inspect the electrode plate 122 by photographing the electrode plate 122 when the electrode plate transfer portion 140 performs the stopping step.

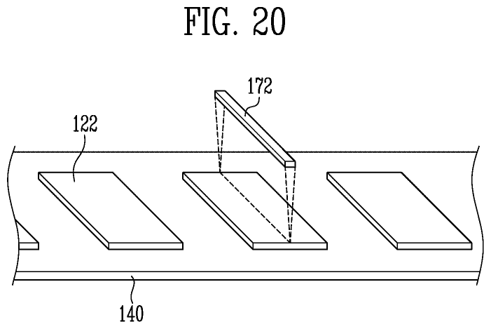

FIG. 20 illustrates a first sensor formed as a vision sensor that scans a predetermined area to inspect one surface of an electrode plate.

As another example, as shown in FIG. 20, the first sensor 172 may be formed as a conventional vision sensor capable of scanning a predetermined area and can inspect whether a material other than the material constituting the electrode plate 122 is attached to one surface of the electrode plate 122.

That is, when the electrode plate transfer portion 140 moves the electrode plate 122 for transfer, the first sensor 172 can scan and inspect the electrode plate 122 moved by the electrode plate transfer portion 140.

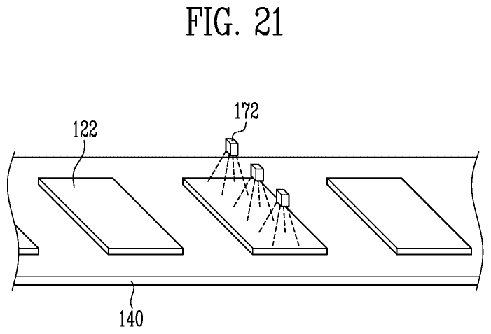

FIG. 21 illustrates a first sensor formed as a magnetic proximity sensor inspecting one surface of an electrode plate.

As another example, as shown in FIG. 21, the first sensor 172 may be formed as a conventional magnetic proximity sensor and can inspect whether a material other than the material constituting the electrode plate 122 is attached to one surface of the electrode plate 122.

At this time, the electrode plate transfer portion 140 may transfer the electrode plate 122 while repeating the aforementioned moving step and stopping step, and the first sensor 172 can inspect the electrode plate 122 when the electrode plate transfer portion 140 performs the moving step or the stopping step.

The second sensor 174 can inspect whether a material other than the material constituting the electrode plate 122 is attached to another surface of the electrode plate 122. Here, the other surface of the electrode plate 122 may be the surface that comes into contact with the electrode plate transfer portion 140 as the electrode plate 122 is transferred by the electrode plate transfer portion 140.

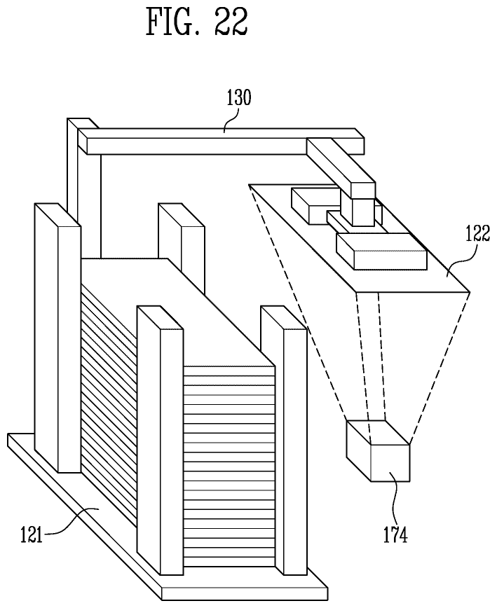

FIG. 22 illustrates a second sensor inspecting another surface of an electrode plate.

As an example, as shown in FIG. 22, the second sensor 174 may be formed as a conventional vision sensor capable of photographing a predetermined area, disposed adjacent to the magazine 121, and configured to photograph another surface of the electrode plate 122 that is conveyed by the electrode plate moving portion 130 to the electrode plate transfer portion 140, where this surface comes into contact with the electrode plate transfer portion 140, thereby inspecting the electrode plate 122.

In other words, since one surface of the electrode plate 122 is gripped by the electrode plate moving portion 130 and conveyed to the electrode plate transfer portion 140, the second sensor 174 can photograph and inspect the other surface of the electrode plate 122, which is not gripped by the electrode plate moving portion 130, from below the electrode plate 122.

By inspecting the electrode plate 122 using the second sensor 174 in this manner, it is possible to check whether foreign substances are attached to the other surface of the electrode plate 122, which is difficult to inspect with the first sensor 172.

The third sensor 176 can inspect whether a plurality of electrode plates 122 conveyed to the electrode plate transfer portion 140 by the electrode plate moving portion 130 are in an overlapped state.

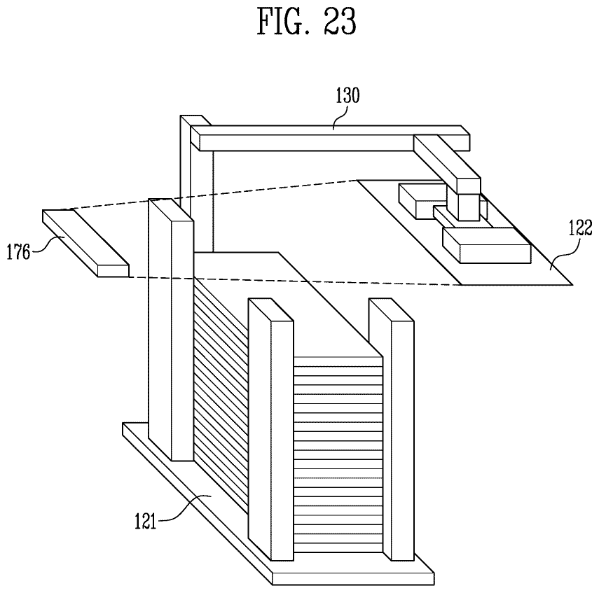

FIG. 23 illustrates a third sensor inspecting a side surface of an electrode plate.

As an example, as shown in FIG. 23, the third sensor 176 may be formed as a conventional vision sensor capable of photographing a predetermined area, disposed adjacent to the magazine 121, and configured to photograph the electrode plate 122 conveyed to the electrode plate transfer portion 140 by the electrode plate moving portion 130 in a direction parallel to the horizontal direction, thereby inspecting the electrode plate 122.

In other words, the third sensor 176 photographs the side of the electrode plate 122 conveyed from the magazine 121 to the electrode plate transfer portion 140, and can inspect whether the electrode plates 122 are conveyed one by one to the electrode plate transfer portion 140.

Next, the separator supply portion will be described.

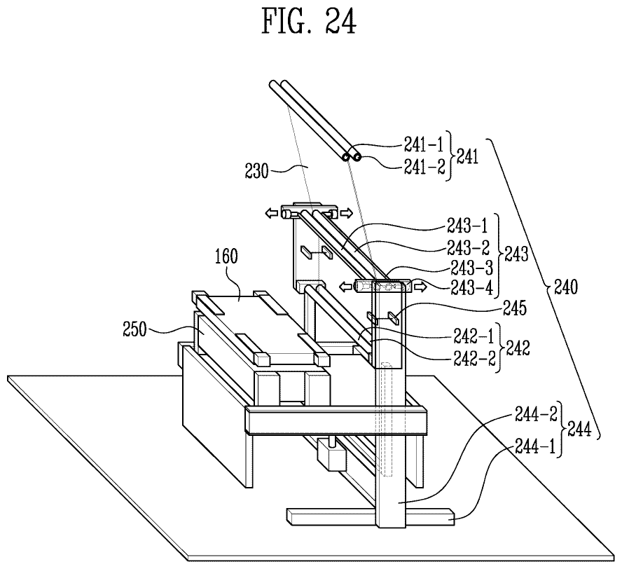

FIG. 24 illustrates an electrode plate stacking portion, a separator stacking portion, and a moving portion.

Referring to FIG. 24, the separator supply portion is configured to supply a separator 230 to the electrode plate stacking portion 160.

For example, the separator supply portion may include a predetermined amount of separator 230 wound in a roll form, and is configured so that the unwinding separator 230 is supplied in a direction toward the electrode plate stacking portion 160.

Such a separator supply portion may be installed above a first guide module to be described later.

Next, the separator stacking portion 240 will be described.

The separator stacking portion 240 reciprocates the separator 230 supplied by the separator supply portion in a first movement direction parallel to a horizontal direction and a second movement direction opposite to the first movement direction, thereby stacking the separator 230 between the positive electrode plates and negative electrode plates alternately supplied and stacked by the electrode plate conveying portion 150.

For example, the separator stacking portion 240 moves the separator 230 in the first movement direction to stack the separator 230 on the positive electrode plate arranged in the electrode plate stacking portion 160, and when the negative electrode plate is stacked on the separator 230 stacked on the positive electrode plate, the separator 230 is moved in the second movement direction to stack the separator 230 on the negative electrode plate.

Such a separator stacking portion 240 may be configured to support a portion of the separator 230 located between the separator supply portion and the electrode plate stacking portion 160, thereby preventing folding of the separator 230.

Specifically, as shown in FIG. 24, the separator stacking portion 240 may include a first guide module 241, a second guide module 242, a third guide module 243, a movement module 244, and an identification module 245.

The first guide module 241 is installed above the electrode plate stacking portion 160 and can guide the movement of the separator 230.

Specifically, referring to FIG. 24, the first guide module 241 may include a first roller 241-1 and a second roller 241-2, which are installed adjacent to each other and rotatable.

The first roller 241-1 and the second roller 241-2 can guide the movement of the separator 230 while allowing the separator 230 to pass between them.

The second guide module 242 is installed below the first guide module 241 and can reciprocate the separator 230 in the first movement direction and the second movement direction.

Specifically, referring to FIG. 24, the second guide module 242 may be installed on the movement module 244 so that the components are adjacent to each other and may include a third roller 242-1 and a fourth roller 242-2, which are rotatable.

The third roller 242-1 and the fourth roller 242-2 allow the separator 230 to pass between them and can be moved by the movement module 244.

That is, the second guide module 242 moves while allowing the separator 230 to pass between the third roller 242-1 and the fourth roller 242-2, and can reciprocate the separator 230 in the first movement direction and the second movement direction, thereby stacking the separator 230 between the alternately stacked positive electrode plate and negative electrode plate.

The third guide module 243 can support a portion of the separator 230 between the first guide module 241 and the second guide module 242 to prevent folding of the separator 230. In other words, the third guide module 243 can prevent the separator 230 from folding and thereby prevent damage to the shape of the separator 230.

Specifically, referring to FIG. 24, the third guide module 243 includes a fifth roller 243-1 and a sixth roller 243-2 disposed adjacent to each other and installed on the movement module 244, and may include a horizontal movement member 243-3 configured to move the fifth roller 243-1 and the sixth roller 243-2 in the first movement direction or the second movement direction with respect to the movement module 244.

At this time, the fifth roller 243-1 and the sixth roller 243-2 can be moved by the movement module 244 and the horizontal movement member 243-3 while allowing the separator 230 to pass between the fifth roller 243-1 and the sixth roller 243-2.

Further, as shown in FIG. 24, since the fifth roller 243-1 and the sixth roller 243-2 are installed on the movement module 244 together with the second guide module 242, they move together with the second guide module 242, which stacks the separator 230 on the electrode plate 122 formed as a positive or negative electrode plate, supporting a portion of the separator 230 to prevent folding of the separator 230.

Meanwhile, since the fifth roller 243-1 and the sixth roller 243-2 move together with the second guide module 242 by the movement module 244, the relative positions between the fifth roller 243-1, the sixth roller 243-2, and the second guide module 242 do not change by the movement of the movement module 244 alone.

However, by the horizontal movement member 243-3 moving the fifth roller 243-1 and the sixth roller 243-2 in the first movement direction or the second movement direction with respect to the movement module 244, the relative positions between the fifth roller 243-1, the sixth roller 243-2, and the second guide module 242 can be changed.

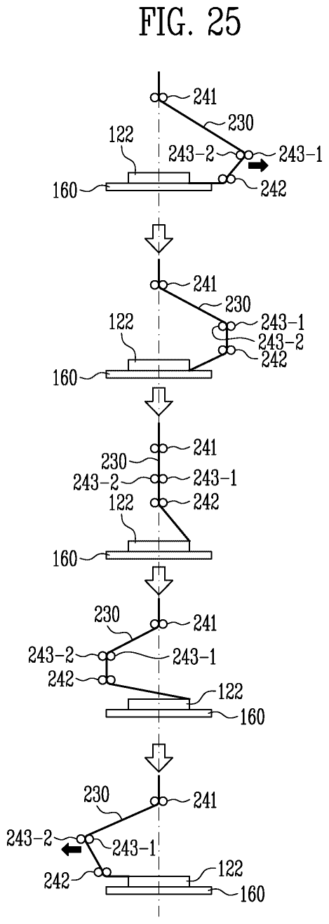

FIG. 25 illustrates a state in which a separator is stacked on an electrode plate by a separator stacking portion on an electrode plate stacking portion fixed in position.

Specifically, as shown in FIG. 25, the fifth roller 243-1 and the sixth roller 243-2 move together with the second guide module 242, which stacks the separator 230 on the electrode plate 122, but can move in the first movement direction or the second movement direction with respect to the second guide module 242.

When the fifth roller 243-1 and the sixth roller 243-2 move in the first movement direction or the second movement direction with respect to the second guide module 242 in this manner, the tension applied to the separator 230 supported by the fifth roller 243-1 and the sixth roller 243-2 can increase.

Therefore, compared to the case where the third guide module 243 does not include the horizontal movement member 243-3 so that the relative positions between the fifth roller 243-1, the sixth roller 243-2, and the second guide module 242 do not change, the case where the third guide module 243 includes the horizontal movement member 243-3 such that the relative positions between the fifth roller 243-1, the sixth roller 243-2, and the second guide module 242 are changed can more effectively prevent the separator 230 from folding and having its shape damaged.

Meanwhile, the third guide module 243 may further include a cushioning member 243-4 and a tension measuring means.

The cushioning member 243-4 may be installed at the first movement direction end and the second movement direction end of the horizontal movement member 243-3, as shown in FIG. 22, and may absorb impacts generated when the fifth roller 243-1 and the sixth roller 243-2 move to the first movement direction end or the second movement direction end of the horizontal movement member 243-3.

Such a cushioning member 243-4 may be composed of a conventional damper, but the configuration of the cushioning member 243-4 is not limited thereto.

The tension measuring means may be installed in the third guide module 243 to measure the tension acting in the first movement direction or the second movement direction on the separator 230 passing between the fifth roller 243-1 and the sixth roller 243-2.

Specifically, the tension measuring means can measure the force by which the fifth roller 243-1 or the sixth roller 243-2 presses the separator 230 in the first movement direction or the second movement direction, thereby measuring the tension acting on the separator 230 in the first movement direction or the second movement direction.

Such tension measuring means may be configured as a conventional load cell, but the configuration of the tension measuring means is not limited thereto.

The movement module 244 can move the second guide module 242 and the third guide module 243, which are installed on the movement module 244, in at least one direction among a direction parallel to the first movement direction, a direction parallel to the second movement direction, and a direction parallel to the vertical direction.

Specifically, as shown in FIG. 24, the movement module 244 may include a horizontal movement member 244-1 and a vertical movement member 244-2.

The horizontal movement member 244-1 is configured to move in the first movement direction or the second movement direction.

The vertical movement member 244-2 is coupled to the horizontal movement member 244-1 and moves in the first movement direction or the second movement direction.

The second guide module 242 and the third guide module 243 are installed on the vertical movement member 244-2, and the vertical movement member 244-2 is configured to move the second guide module 242 and the third guide module 243 in a direction parallel to the vertical direction.

Meanwhile, although not shown in the drawings, the movement module 244 may be configured to perform reciprocating movement along an arc, so that the second guide module 242 and the third guide module 243 supported by the movement module 244 can be moved to reciprocate along an arc.

The identification module 245 is installed in the separator stacking portion 240 and can identify whether one surface and the other surface of the separator 230 are formed flat.

For example, as shown in FIG. 24, the identification module 245 is installed on the movement module 244 and can identify whether the shape of the separator 230 located between the second guide module 242 and the third guide module 243 is damaged.

Such an identification module 245 may be configured as a conventional vision sensor capable of capturing and identifying images, but the configuration of the identification module 245 is not limited thereto.

Next, the moving portion 250 will be described.

Referring to FIG. 24, the moving portion 250 can move the electrode plate stacking portion 210 in at least one direction among a direction parallel to the first movement direction, a direction parallel to the second movement direction, and a direction parallel to the vertical direction.

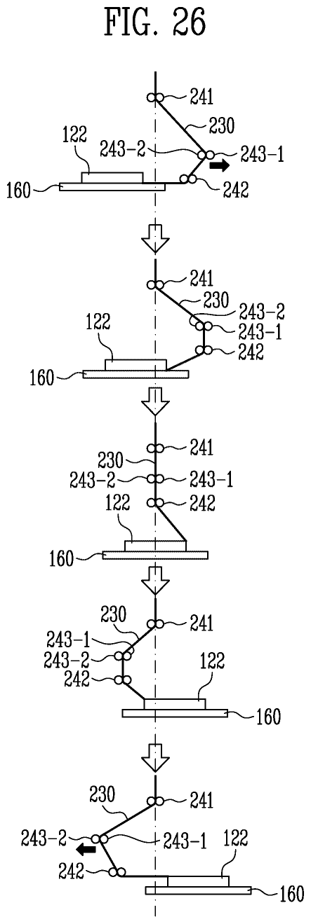

FIG. 26 illustrates a state in which a separator is stacked on an electrode plate by a separator stacking portion on an electrode plate stacking portion moving in a horizontal direction.

At this time, as shown in FIG. 26, the moving portion 250 moves the electrode plate stacking portion 160 in the second movement direction when the movement module 244 moves the second guide module 242 and the third guide module 243 in the first movement direction, and moves the electrode plate stacking portion 160 in the first movement direction when the movement module 244 moves the second guide module 242 and the third guide module 243 in the second movement direction.

Thus, when the second guide module 242 and the third guide module 243 move in opposite directions and the separator 230 is stacked on the electrode plate 122 by the electrode plate stacking portion 160, the second guide module 242 and the third guide module 243 move a shorter distance in the first or second movement direction to stack the separator 230 on the electrode plate 122 compared to a case where only the second and third guide modules move on a fixed electrode plate stacking portion 160.

That is, since the moving range of the horizontal moving member 244-1 of the movement module 244 can be reduced, the volume of the electrode assembly manufacturing apparatus 1 can be reduced.

Therefore, the electrode assembly manufacturing apparatus 1 can be installed in a relatively narrower space.

In addition, the moving portion 250 can move the electrode plate stacking portion 160 in a direction parallel to the vertical direction to position the electrode plate 122, which is at the uppermost position among the electrode plates stacked in the electrode plate stacking portion 160 and on which the separator 230 is to be stacked, at a predetermined position.

Next, the control portion will be described.

The control portion can control the operation of components of the electrode assembly manufacturing apparatus 1 so that the separator 230 does not fold and its shape is not damaged. Such a control portion can be configured as a conventional computer, but the configuration of the control portion is not limited thereto.

For example, the control portion can control the speed at which the separator supply portion supplies the separator 230, the movement of the movement module 244, and the movement of the moving portion 250 so that the tension applied to the separator 230 stacked on the electrode plate 122 maintains a predetermined reference tension.

Specifically, the control portion can control the speed at which the separator supply portion supplies the separator 230, the movement of the movement module 244, and the movement of the moving portion 250 so that the tension of the separator 230 measured by the tension measuring means included in the third guide module 243 maintains a predetermined reference tension.

In another example, except when the identification module 245 identifies that one surface and the other surface of the separator 230 are flat, the control portion can control the speed at which the separator supply portion supplies the separator 230, the movement of the movement module 244, and the movement of the moving portion 250 so that one surface and the other surface of the separator 230 become flat.

Hereafter, a method for manufacturing an electrode assembly according to an embodiment of the present disclosure will be described.

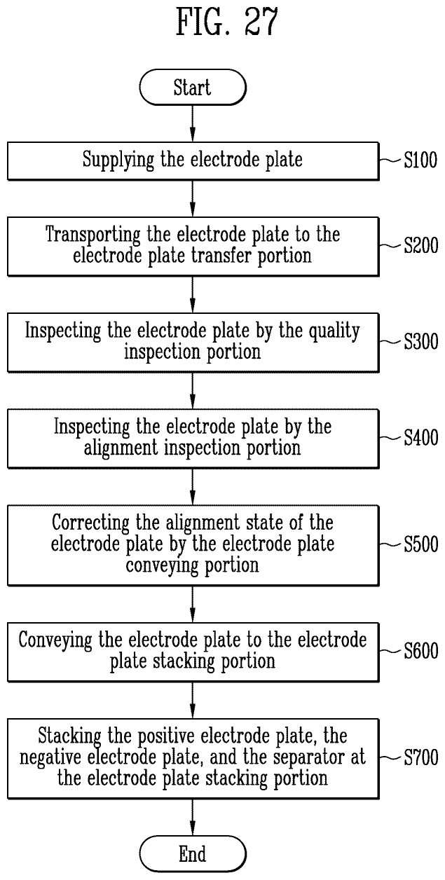

FIG. 27 is a flowchart illustrating a method for manufacturing an electrode assembly according to an embodiment of the present disclosure.

Referring to FIG. 27, the electrode assembly manufacturing method may comprise: a first step S100 of supplying an electrode plate 122; a second step S200 of conveying the electrode plate 122 to the electrode plate transfer portion 140; a third step S300 of inspecting the electrode plate 122 with the quality inspection portion 170; a fourth step S400 of inspecting the electrode plate 122 with the alignment inspection portion 145; a fifth step S500 of correcting the alignment state of the electrode plate 122; a sixth step S600 of conveying the electrode plate 122 to the electrode plate stacking portion 160; and a seventh step S700 of stacking the positive electrode plate, the negative electrode plate, and the separator in the electrode plate stacking portion 160.

First, the first step S100 will be described.

The first step S100 is a step of supplying an electrode plate 122 formed as a positive electrode plate or a negative electrode plate to the electrode plate supply portion 120.

At this time, the configuration of the electrode plate supply portion 120 is the same as the configuration of the electrode plate supply portion 120 of the above-described electrode assembly manufacturing apparatus 1.

Next, the second step S200 will be described.

The second step S200 is a step of conveying the electrode plate 122 from the electrode plate supply portion 120 to the electrode plate transfer portion 140 by the electrode plate moving portion 130.

At this time, the configurations of the electrode plate moving portion 130 and the electrode plate transfer portion 140 are the same as those of the above-described electrode assembly manufacturing apparatus 1.

Next, the third step S300 will be described.

The third step S300 is a step of inspecting the electrode plate 122 with the quality inspection portion 170.

The configuration of the quality inspection portion 170 is the same as the configuration of the quality inspection portion 170 of the above-described electrode assembly manufacturing apparatus 1.

Next, the fourth step S400 will be described.

The fourth step S400 is a step of inspecting the electrode plate 122 with the alignment inspection portion 145.

The configuration of the alignment inspection portion 145 is the same as the configuration of the alignment inspection portion 145 of the above-described electrode assembly manufacturing apparatus 1.

Next, the fifth step S500 will be described.

The fifth step S500 is a step of correcting the alignment state of the electrode plate 122 by the electrode plate conveying portion 150.

The configuration of the electrode plate conveying portion 150 is the same as the configuration of the electrode plate conveying portion 150 of the above-described electrode assembly manufacturing apparatus 1.

Next, the sixth step S600 will be described.

The sixth step S600 is a step of conveying the electrode plate 122 to the electrode plate stacking portion 160 by the electrode plate conveying portion 150.

The configuration of the electrode plate stacking portion 160 is the same as the configuration of the electrode plate stacking portion 160 of the above-described electrode assembly manufacturing apparatus 1.

Next, the seventh step S700 will be described.

The seventh step S700 is a step of operating the separator stacking portion 240 and the moving portion 250 in the electrode plate stacking portion 160 to stack the positive electrode plate, negative electrode plate, and separator 230.

The configurations of the separator stacking portion 240 and the moving portion 250 are the same as the configurations of the separator stacking portion 240 and the moving portion 250 of the above-described electrode assembly manufacturing apparatus 1.

As described above, the electrode assembly manufacturing apparatus and the electrode assembly manufacturing method according to the present disclosure provide the effect of preventing defects in a battery cell including an electrode assembly manufactured using an electrode plate by detecting an electrode plate having a damaged shape through an inspection sensor and discharging it to the outside, or by preventing the shape of the electrode plate gripped by a mechanism that transports the electrode plate from being damaged.

In addition, by inspecting the alignment state of the electrode plate through the alignment inspection portion and correcting the alignment state of the electrode plate through the electrode plate conveying portion, an effect of preventing defects in a battery cell including an electrode assembly manufactured using the electrode plate is provided.

In addition, since the quality inspection portion detects an electrode plate with foreign substances attached or an electrode plate having a state in which multiple electrode plates are overlapped, the use of such electrode plates in manufacturing the electrode assembly can be prevented, thereby providing an effect of preventing defects in a battery cell including the electrode assembly.

In addition, since the third guide module of the separator stacking portion supports a portion of the separator and can apply a predetermined tension to the separator, the use of a separator having a damaged shape in manufacturing the electrode assembly can be prevented, thereby providing an effect of preventing defects in a battery cell including the electrode assembly.

The foregoing description of the present disclosure is provided for illustration only, and those skilled in the art to which the present disclosure pertains will understand that various modifications and variations can be made without departing from the technical spirit or essential features of the present disclosure. Therefore, the embodiments described above are to be considered illustrative in all respects and not restrictive. For example, each component described as a single unit may be implemented in a distributed manner, and likewise, components described as distributed may be implemented in an integrated manner.

The scope of the present disclosure is indicated not by the detailed description above, but by the claims that follow, and all changes or modifications derived from the meaning, scope, and equivalents of the claims are to be construed as being included within the scope of the present disclosure.

1. An electrode assembly manufacturing apparatus comprising:
an electrode plate supply portion configured to supply an electrode plate formed as a positive electrode plate or a negative electrode plate;
an electrode plate transfer portion configured to transfer the electrode plate;
an electrode plate moving portion configured to move the electrode plate from the electrode plate supply portion to the electrode plate transfer portion;
an electrode plate stacking portion on which the positive electrode plate, the negative electrode plate, and a separator are stacked;
an electrode plate conveying portion configured to convey the electrode plate, transferred by the electrode plate transfer portion, to the electrode plate stacking portion such that the positive electrode plate and the negative electrode plate are alternately supplied one by one to the electrode plate stacking portion;
a separator supply portion configured to supply the separator to the electrode plate stacking portion; and
a separator stacking portion configured to reciprocate the separator in a first movement direction parallel to a horizontal direction and a second movement direction opposite to the first movement direction, and to stack the separator between the alternately stacked positive electrode plate and negative electrode plate,
wherein the separator stacking portion is configured to support a portion of the separator located between the separator supply portion and the electrode plate stacking portion so as to prevent folding of the separator.

2. The electrode assembly manufacturing apparatus according to claim 1, wherein the separator stacking portion comprises:
a first guide module disposed above the electrode plate stacking portion and configured to guide movement of the separator;
a second guide module disposed below the first guide module and configured to reciprocate the separator in a first movement direction and a second movement direction opposite to the first movement direction; and
a third guide module disposed between the first guide module and the second guide module and configured to support a portion of the separator to prevent folding of the separator.

3. The electrode assembly manufacturing apparatus according to claim 2, wherein the separator stacking portion further comprises a movement module configured to move the second guide module and the third guide module in at least one direction among a direction parallel to the first movement direction, a direction parallel to the second movement direction, and a direction parallel to a vertical direction.

4. The electrode assembly manufacturing apparatus according to claim 3, wherein the third guide module comprises:
a fifth roller and a sixth roller disposed adjacent to each other and installed in the movement module; and
a horizontal movement member configured to move the fifth roller and the sixth roller in the first movement direction or the second movement direction with respect to the movement module;
wherein the fifth roller and the sixth roller are moved by the movement module and the horizontal movement member while allowing the separator to pass between the fifth roller and the sixth.

5. The electrode assembly manufacturing apparatus according to claim 4, further comprising a moving portion configured to move the electrode plate stacking portion in at least one direction among a direction parallel to the first movement direction, a direction parallel to the second movement direction, and a direction parallel to a vertical direction.

6. The electrode assembly manufacturing apparatus according to claim 5, wherein the moving portion is configured to move the electrode plate stacking portion in the second movement direction when the movement module moves the second guide module and the third guide module in the first movement direction, and to move the electrode plate stacking portion in the first movement direction when the movement module moves the second guide module and the third guide module in the second movement direction.

7. The electrode assembly manufacturing apparatus according to claim 6, further comprising a control portion configured to control a speed at which the separator supply portion supplies the separator, movement of the movement module, and movement of the moving portion.

8. The electrode assembly manufacturing apparatus according to claim 7, wherein the third guide module includes a tension measuring means configured to measure a tension applied to the separator in the first movement direction or the second movement direction as the separator passes between the fifth roller and the sixth roller, and the control portion is configured to control the speed at which the separator supply portion supplies the separator, movement of the movement module, and movement of the moving portion so that the tension measured by the tension measuring means is maintained at a predetermined reference tension.

9. The electrode assembly manufacturing apparatus according to claim 1, wherein the electrode plate supply portion comprises a magazine in which at least one electrode plate is loaded,
and the magazine comprises:
a support plate configured to support the electrode plate and to be capable of moving up and down; and
an electrode plate detection sensor configured to detect a position of the electrode plate,
wherein the electrode plate detection sensor is configured to detect whether the electrode plate is positioned at a predetermined gripping position to be gripped by the electrode plate moving portion, and the electrode plate moving portion is configured to grip the electrode plate loaded in the magazine when the electrode plate is positioned at the gripping position.

10. The electrode assembly manufacturing apparatus according to claim 9, wherein the electrode plate supply portion comprises:
an inspection sensor configured to detect whether the electrode plate is formed in a predetermined shape; and
an electrode plate discharge mechanism configured to discharge the electrode plate to outside the electrode plate supply portion when the electrode plate is not formed in the predetermined shape.

11. The electrode assembly manufacturing apparatus according to claim 1, further comprising an alignment inspection portion configured to inspect whether the electrode plate is in a predetermined reference alignment state when the electrode plate, which is transferred by the transfer portion, is positioned at a predetermined conveying position to be gripped by the electrode plate conveying portion,
wherein the alignment inspection portion is configured to calculate correction information for correcting the alignment state of the electrode plate and to transmit the correction information to the electrode plate conveying portion, if the alignment state of the electrode plate is not in the reference alignment state.

12. The electrode assembly manufacturing apparatus according to claim 11, wherein the electrode plate conveying portion is configured to grip the electrode plate, correct its alignment state based on the correction information, and then convey the electrode plate to the electrode plate stacking portion.

13. The electrode assembly manufacturing apparatus according to claim 12, wherein when a state of the electrode plate conveying portion is changed by moving the electrode plate based on the correction information, the electrode plate conveying portion is reset to a predetermined origin state, and
the electrode plate conveying portion is configured to preliminarily change its state based on the correction information before gripping another one of the electrode plates, after conveying one of the electrode plates to the electrode plate stacking portion.

14. The electrode assembly manufacturing apparatus according to claim 9, further comprising a quality inspection portion including a first sensor configured to inspect whether a material other than the material constituting the electrode plate is attached to one surface of the electrode plate.

15. The electrode assembly manufacturing apparatus according to claim 14, wherein the quality inspection portion comprises a second sensor configured to inspect whether a material other than the material constituting the electrode plate is attached to another surface of the electrode plate that comes into contact with the electrode plate transfer portion.

16. The electrode assembly manufacturing apparatus according to claim 15, wherein the second sensor is a vision sensor configured to record a video of a predetermined area, is disposed adjacent to the magazine, and is configured to record a video of the other surface of the electrode plate conveyed to the electrode plate transfer portion by the electrode plate moving portion to inspect the electrode plate.

17. The electrode assembly manufacturing apparatus according to claim 16, further comprising a third sensor configured to inspect whether a plurality of electrode plates conveyed to the electrode plate transfer portion by the electrode plate moving portion are in an overlapped state.

18. The electrode assembly manufacturing apparatus according to claim 17, wherein the third sensor is formed as a vision sensor configured to record a video of a predetermined area, is disposed adjacent to the magazine, and is configured to inspect the electrode plate by recording a video of the electrode plate in a direction parallel to a horizontal direction as the electrode plate is conveyed to the electrode plate transfer portion by the electrode plate moving portion.

19. A method for manufacturing an electrode assembly, comprising:
supplying an electrode plate formed as a positive electrode plate or a negative electrode plate through an electrode plate supply portion;
transporting the electrode plate from the electrode plate supply portion to an electrode plate transfer portion using an electrode plate moving portion;
transferring the electrode plate by the electrode plate transfer portion;
conveying the electrode plate, transferred by the electrode plate transfer portion, to an electrode plate stacking portion using an electrode plate conveying portion such that the positive electrode plate and the negative electrode plate are alternately supplied one by one to the electrode plate stacking portion;
supplying a separator to the electrode plate stacking portion through a separator supply portion; and
stacking the separator between the alternately stacked positive electrode plate and negative electrode plate by reciprocating the separator in a first movement direction parallel to a horizontal direction and a second movement direction opposite to the first movement direction using a separator stacking portion,
wherein the separator stacking portion is configured to support a portion of the separator located between the separator supply portion and the electrode plate stacking portion so as to prevent folding of the separator.

20. The method for manufacturing an electrode assembly according to claim 19, wherein the separator stacking portion comprises:
a first guide module disposed above the electrode plate stacking portion and configured to guide movement of the separator;
a second guide module disposed below the first guide module and configured to reciprocate the separator in a first movement direction and a second movement direction opposite to the first movement direction; and
a third guide module disposed between the first guide module and the second guide module and configured to support a portion of the separator to prevent folding of the separator.

21-25. (canceled)
